(19) United States
(12) Patent Application Publication
(10) Pub. No.: US 2026/0221822 A1
(43) Pub. Date: Jul. 30, 2026

(54) ROTOR FOR ELECTRIC MACHINE, ELECTRIC MACHINE COMPRISING THE ROTOR, AND METHOD FOR MANUFACTURING THE ELECTRIC MACHINE

(71) Applicant: ABB Schweiz AG, Baden (CH)

(72) Inventors: Jouni Ikäheimo, Vaasa (FI); Tero Känsäkangas, Vaasa (FI)

(21) Appl. No.: 19/450,068

(22) Filed: Jan. 15, 2026

(30) Foreign Application Priority Data
Jan. 27, 2025 (EP) 25154013.4

(51) Int. Cl. H02K 1/24

(52) U.S. Cl. CPC H02K 1/246

(57) ABSTRACT

A rotor for an electric machine comprises a rotor core formed from a plurality of rotor sheets. Each rotor sheet includes multiple flux guide sections, and each flux guide section comprises several flux paths and flux barriers. In a first flux guide section, one of the flux barriers includes a bridge that interrupts the barrier, while another flux barrier in the same section does not include a bridge. In a second flux guide section, the configuration is reversed, such that the flux barrier that includes a bridge in the first flux guide section does not include a bridge, and the other flux barrier includes a bridge. This alternating arrangement of bridges across different flux guide sections influences the magnetic flux distribution within the rotor.

### CROSS-REFERENCE TO RELATED APPLICATIONS

This application claims priority to European Patent Application No. 25154013.4 filed on Jan. 27, 2025, and titled “ROTOR FOR ELECTRIC MACHINE, ELECTRIC MACHINE COMPRISING THE ROTOR, AND METHOD FOR MANUFACTURING THE ELECTRIC MACHINE”, the entire contents of which are hereby incorporated by reference.

### TECHNICAL FIELD

The present disclosure relates to a rotor for an electric machine. The present disclosure also relates to an electric machine comprising said rotor, and to a method for manufacturing an electric machine.

### BACKGROUND

In an electric machine rotor provided with a plural number of magnetic poles, arranged substantially at equal intervals along the circumference of the rotor, each magnetic pole has a direct pole axis, or a direct axis. Two adjacent direct pole axes form an angle that is bisected by a quadrature axis. The reactance corresponding to the direct pole axis is called a direct-axis reactance and the reactance corresponding to the quadrature axis is called a quadrature-axis reactance. A reluctance torque is proportional to the difference of the inverse values of the quadrature-axis reactance and the direct-axis reactance (the difference can be written as 1/X_{q}−1/X_{d}). Therefore, a reluctance torque can be increased by increasing the direct-axis reactance or by reducing the quadrature-axis reactance.

A known rotor of a reluctance machine comprises a rotor core having a plurality of rotor sheets stacked in an axial direction. Each of the plurality of rotor sheets comprises a plurality of flux guide sections located along circumferential direction of the rotor sheet, each of the plurality of flux guide sections comprising a plurality of flux paths made of a material of high permeance and a plurality of flux barriers made of a material of low permeance. The flux paths and flux barriers are located alternately along the radial direction of the flux guide section. For mechanical reasons, there are bridges made of a material of high permeance connecting some adjacent flux paths.

The bridges should be as narrow as possible in order to avoid undesirable leak flux from one flux path to another. The leak flux decreases efficiency and maximum torque and increases no-load current, thereby deteriorating electrical properties of the electric machine. Therefore, the narrower the bridges are the better electrical properties of the electric machine.

Conventionally, a rotor of a reluctance machine has been manufactured by punching flux barriers and other required openings into ferromagnetic sheets and stacking these sheets to form the rotor core. A plurality of rotor sheets manufactured by punching are stacked between end plates, the plurality of rotor sheets being attached to the end plates by bolts extending through the rotor sheets.

A problem associated with punching is that narrow bridges cannot be formed with it.

A known rotor for a synchronous reluctance motor is disclosed in EP2744076B1. Said publication discloses a rotor structure with reduced quadrature-axis reactance.

### BRIEF DESCRIPTION

An object of the present disclosure is to improve electrical properties of an electric machine whose rotor sheets comprise bridges while being obtainable by punching. The objects of the present disclosure are achieved by a rotor which is characterized by what is stated in the independent claim 1. Some embodiments of the present disclosure are disclosed in the dependent claims.

The present disclosure is based on the idea of providing a rotor for an electric machine such that the quadrature-axis flux is forced to flow in the axial direction of the rotor more than in known rotors, thereby reducing the quadrature-axis reactance.

A rotor according to the present disclosure has a plurality of rotor sheets each of which comprises two types of flux guide sections each comprising a plurality of flux paths and a plurality of flux barriers. In a first flux guide section, one of the plurality of flux barriers has a bridge interrupting the flux barrier and another of the plurality of flux barriers does not have a bridge interrupting the flux barrier. In a second flux guide section, said one of the plurality of flux barriers does not have a bridge interrupting the flux barrier and said another of the plurality of flux barriers has a bridge interrupting the flux barrier.

An advantage of the present disclosure is that electrical properties of an electric machine having rotor sheets comprising bridges crossing flux barriers can be further improved without the need to reduce the width of the bridges in individual rotor sheets. The present disclosure enables increasing power factor of a synchronous reluctance motor.

### BRIEF DESCRIPTION OF DRAWINGS

In the following, the present disclosure will be described in greater detail by some embodiments with reference to the attached drawings.

FIG. 1 shows a rotor sheet of a rotor according to an embodiment of the present disclosure.

FIG. 2 shows a rotor comprising a plurality of rotor sheets shown in FIG. 1.

### DETAILED DESCRIPTION

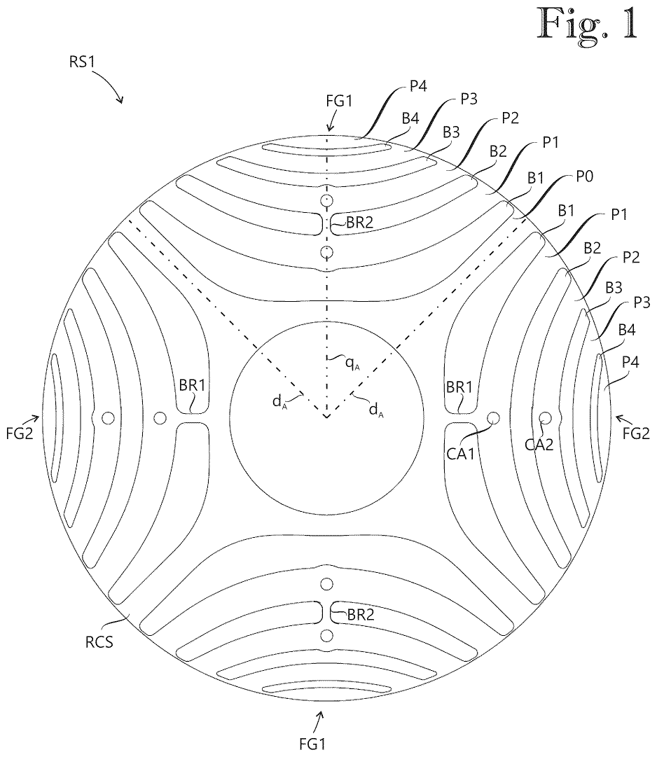

FIG. 1 shows a rotor sheet RS1 of a rotor core for a four-pole rotor. The rotor sheet RS1 is adapted for a synchronous reluctance machine.

The rotor sheet RS1 comprises four flux guide sections located along the circumferential direction of the rotor sheet. The four flux guide sections comprise two first flux guide sections FG1 and two second flux guide sections FG2. The first flux guide sections FG1 and second flux guide sections FG2 alternate in the circumferential direction of the rotor sheet such that after a first flux guide section FG1 there is a second flux guide section FG2, and after a second flux guide section FG2 there is a first flux guide section FG1.

Each of the flux guide sections comprises four flux paths P1, P2, P3 and P4 made of a material of high permeance and four flux barriers B1, B2, B3 and B4 made of a material of low permeance. Flux paths and flux barriers are located alternately along the radial direction of the corresponding flux guide section.

The material of low permeance is selected on the basis of the type of electric machine. In a reluctance motor, the flux barriers may be filled with solid or powdery substances that are weakly conductive with regard to the magnetic flux and electricity. Useful substances include, depending on the embodiment, resins, plastics and carbon fibers. Naturally, in some embodiments, the material of low permeance is air.

Each of the flux paths P1-P4 is arranged to conduct magnetic flux from a first extremity of the flux path to a second extremity thereof, both the first extremity and the second extremity ending at the rotor surface and being spaced apart from one another at the rotor surface in the direction of its circumference.

The flux paths P1-P3 are arc-shaped paths. Flux paths P1-P3 are shaped in such a way that the circumferential extremities, namely those referred above to as the first and the second extremities, are at a greater radial distance from the mid-axis of the rotor than an outer surface of a center portion of the flux path in question. In other words, the flux paths P1-P3 are curved inwards.

Each flux barrier B1-B4 is arranged to increase the ratio of direct-axis reactance to quadrature-axis reactance. In other words, each flux barrier B1-B4 is arranged to provide a high magnetic resistance between adjacent elements made of a material of high permeance.

The rotor sheet RS1 further comprises a center section RCS. The center section RCS is substantially X-shaped, with each tip of the X extending to the surface of the rotor. The direct pole axis d_{A} of each magnetic pole passes through the portion of the center section RCS that extends to the rotor surface. In the middle of the center section RCS there is a hole arranged to receive a rotor shaft.

The center section RCS is made of material of high permeance. Therefore, the center section RCS forms a center flux path P0 for each flux guide section. Each center flux path P0 is located adjacent to a respective flux barrier B1 and is arranged to conduct magnetic flux from a first extremity of the center flux path to a second extremity thereof, with both the first extremity and the second extremity ending at the rotor surface.

In the first flux guide section FG1, flux barrier B2 has a bridge BR2 interrupting the flux barrier B2 while the rest of the flux barriers B1, B3 and B4 do not have any bridges. The flux barrier B2 is the second innermost of the four flux barriers in the radial direction.

In the second flux guide section FG2, flux barrier B1 has a bridge BR1 interrupting the flux barrier B1 while the rest of the flux barriers B2, B3 and B4 do not have any bridges. The flux barrier B1 is the innermost of the four flux barriers in the radial direction.

Both bridge BR1 and bridge BR2 are made of a material of high permeance. In an embodiment, the bridges are made of the same material as the flux paths.

Widths of bridges BR1 and BR2 are substantially the same. In an embodiment, each of the bridges has a width greater than or equal to 4 mm. Basically, the thinner the bridge the better. Therefore, it is typically the manufacturing process of the rotor sheet that defines the smallest feasible width for the bridges. Herein, a width of a bridge is perpendicular to both the axial direction of the rotor and the radial direction of the rotor.

Each of the bridges BR1 and BR2 is positioned such that a quadrature axis of the rotor traverses the bridge. In FIG. 1, only a quadrature axis q_{A} traversing flux guide section FG1 is depicted, along with two direct pole axes d_{A} which form an angle that is bisected by the quadrature axis q_{A}. Each of the bridges BR1 and BR2 is symmetrical with relation to corresponding quadrature axis.

Except for the bridges, the first flux guide section FG1 and the second flux guide section FG2 are identical. The rotor sheet RS1 is symmetrical with relation to two lines, one of which coincides with a quadrature axis bisecting the first flux guide section FG1 and the other coincides with a quadrature axis bisecting the second flux guide section FG2.

Rotor sheet RS1 comprises more bridges close to the center axis of the rotor sheet than further from the center axis of the rotor sheet. The innermost flux barriers B1 have a total of two bridges. The second innermost flux barriers B2 also have a total of two bridges. The second outermost flux barriers B3 and the outermost flux barriers B4 do not have any bridges.

Rotor sheet RS1 comprise a peripheral bridge assembly. The peripheral bridge assembly comprises a plurality of peripheral bridges made of a material of high permeance. The peripheral bridges form, together with outer portions of flux paths, an unbroken ring made of a material of high permeance, with the unbroken ring defining an outer circumference of the rotor sheet RS1. The unbroken ring strengthens the structure of the rotor sheet RS1. In an embodiment, the peripheral bridge assembly is made of the same material as the flux paths.

Rotor sheet RS1 has eight connection apertures. Each flux path P1 comprises a connection aperture CA1, and each flux path P2 comprises a connection aperture CA2. The connection apertures are adapted to receive bolts for pressing rotor sheets of a stack together. In an alternative embodiment, each of the rotor sheets comprises a plurality of connection apertures. In a further alternative embodiment, the rotor sheets are attached to each other by gluing.

A rotor core comprises a plurality of rotor sheets stacked in an axial direction. In an embodiment, the plurality of rotor sheets comprises exclusively rotor sheets RS1 such that the plurality of rotor sheets RS1 are arranged in a plurality of rotor sheet groups, with each rotor sheet group comprising at least one rotor sheet RS1. Rotor sheets of each group are located successively to each other in the axial direction.

In each rotor sheet group, the first flux guide sections FG1 are aligned with each other and the second flux guide sections FG2 are aligned with each other. In the rotor core, successive rotor sheet groups are offset by π/2 radians (90°) such that the first flux guide sections FG1 of a rotor sheet group are aligned with the second flux guide sections FG2 of the adjacent rotor sheet group.

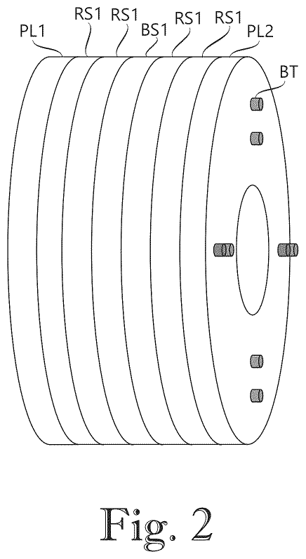

FIG. 2 shows a rotor comprising four rotor sheets RS1, a barrier sheet BS1 and end plates PL1 and PL2. The four rotor sheets RS1 are arranged in two rotor sheet groups, each rotor sheet group comprising two rotor sheets RS1. The rotor sheets of each group are located successively to each other in the axial direction, wherein in each rotor sheet group, the first flux guide sections FG1 are aligned with each other, and wherein the first flux guide sections FG1 of a rotor sheet group are aligned with the second flux guide sections FG2 of the adjacent rotor sheet group.

Barrier sheet BS1 is located between the two rotor sheet groups. The diameter of the barrier sheet BS1 is substantially the same as the diameter of the rotor sheets RS1. Barrier sheet BS1 is made of a material of low permeance. In an embodiment, the barrier sheet is made of stainless steel.

In an embodiment, the thickness of the barrier sheet is less than the thickness of rotor sheets of the rotor core. In an alternative embodiment, the thickness of the barrier sheet is less than 1 mm.

End plate PL1 is located at a first end of the rotor, and end plate PL2 is located at a second end of the rotor. The two rotor sheet groups and the barrier sheet BS1 are pressed between the end plates PL1 and PL2 by bolts BT extending through the connection apertures CA1 and CA2.

In an embodiment, each rotor sheet is manufactured from a ferromagnetic plate by a single punching process, wherein the bridges of flux barriers are also formed by the single punching process. In an embodiment in which the rotor comprises exclusively one type of rotor sheet, the rotor sheets are formed with one punching tool. Said rotor sheets of one type are automatically rotated for stacking.

The present disclosure is not limited to reluctance machines. For example, it is possible to use a rotor according to the present disclosure in a permanent magnet machine. Basically, it is possible to use the present disclosure in any stacked rotor having bridges. Further, the present disclosure is usable for any number of poles.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A rotor for an electric machine comprising a rotor core having a plurality of rotor sheets stacked in an axial direction, each of the plurality of rotor sheets comprising a plurality of flux guide sections located along circumferential direction of the rotor sheet, each of the plurality of flux guide sections comprising a plurality of flux paths made of a material of high permeance and a plurality of flux barriers made of a material of low permeance located alternately along radial direction of the flux guide section, the plurality of flux guide sections comprising a first flux guide section in which one of the plurality of flux barriers has a bridge interrupting the flux barrier and another of the plurality of flux barriers does not have a bridge interrupting the flux barrier.
wherein the plurality of flux guide sections comprises a second flux guide section in which the one of the plurality of flux barriers does not have a bridge interrupting the flux barrier and the another of the plurality of flux barriers has a bridge interrupting the flux barrier, and wherein each of the bridges is made of a material of high permeance.

2. The rotor according to claim 1, wherein the plurality of rotor sheets are arranged in a plurality of rotor sheet groups, each rotor sheet group comprising at least one rotor sheet, wherein rotor sheets of each group are located successively to each other in the axial direction, wherein in each rotor sheet group, the first flux guide sections are aligned with each other, and wherein the first flux guide sections of a rotor sheet group are aligned with the second flux guide sections of adjacent rotor sheet group.

3. The rotor according to claim 1, wherein each of the plurality of rotor sheets is identical with the rest of the plurality of rotor sheets.

4. The rotor according to claim 1, wherein each flux guide section has an equal number of flux paths and an equal number of flux barriers compared to the other flux guide sections.

5. The rotor according to claim 4, wherein except for the bridges, the first flux guide section and the second flux guide section are identical.

6. The rotor according to claim 1, wherein the plurality of flux guide sections of each of the plurality of rotor sheets comprises exclusively first flux guide sections and second flux guide sections.

7. The rotor according to claim 1, wherein widths of bridges in the first flux guide section and in the second flux guide section are substantially the same.

8. The rotor according to claim 1, wherein each of the bridges is positioned such that a quadrature axis of the rotor traverses the bridge.

9. The rotor according to claim 1, wherein the one of the plurality of flux barriers is an innermost of the plurality of flux barriers in the radial direction and the another of the plurality of flux barriers is a second innermost of the plurality of flux barriers in the radial direction.

10. The rotor according to claim 2, wherein the rotor core comprises at least one barrier sheet located between adjacent rotor sheet groups, and wherein the at least one barrier sheet is made of a material of low permeance.

11. The rotor according to claim 10, wherein the at least one barrier sheet is made of stainless steel.

12. The rotor according to claim 1, wherein the rotor further comprises a first end plate and a second end plate spaced apart in a longitudinal direction parallel to the axis of rotation of the rotor, and wherein the plurality of rotor sheets is stacked between the first end plate and a second end plate.

13. The rotor according to claim 1, wherein the rotor is a rotor for a reluctance machine.

14. An electric machine comprising a rotor and a stator, wherein the rotor of the electric machine comprises:
a rotor core having a plurality of rotor sheets stacked in an axial direction, each of the plurality of rotor sheets comprising a plurality of flux guide sections located along circumferential direction of the rotor sheet, each of the plurality of flux guide sections comprising a plurality of flux paths made of a material of high permeance and a plurality of flux barriers made of a material of low permeance located alternately along radial direction of the flux guide section, the plurality of flux guide sections comprising a first flux guide section in which one of the plurality of flux barriers has a bridge interrupting the flux barrier and another of the plurality of flux barriers does not have a bridge interrupting the flux barrier,
wherein the plurality of flux guide sections comprises a second flux guide section in which the one of the plurality of flux barriers does not have a bridge interrupting the flux barrier and the another of the plurality of flux barriers has a bridge interrupting the flux barrier, and wherein each of the bridges is made of a material of high permeance.

15. A method for manufacturing an electric machine, wherein:
the electric machine comprises a rotor and a stator, wherein the rotor of the electric machine comprises:
a rotor core having a plurality of rotor sheets stacked in an axial direction, each of the plurality of rotor sheets comprising a plurality of flux guide sections located along circumferential direction of the rotor sheet, each of the plurality of flux guide sections comprising a plurality of flux paths made of a material of high permeance and a plurality of flux barriers made of a material of low permeance located alternately along radial direction of the flux guide section, the plurality of flux guide sections comprising a first flux guide section in which one of the plurality of flux barriers has a bridge interrupting the flux barrier and another of the plurality of flux barriers does not have a bridge interrupting the flux barrier,
wherein the plurality of flux guide sections comprises a second flux guide section in which the one of the plurality of flux barriers does not have a bridge interrupting the flux barrier and the another of the plurality of flux barriers has a bridge interrupting the flux barrier, and wherein each of the bridges is made of a material of high permeance, and
the method comprises:
an activity of providing the plurality of rotor sheets, the activity comprising a punching process.

16. The electric machine according to claim 14, wherein the plurality of rotor sheets are arranged in a plurality of rotor sheet groups, each rotor sheet group comprising at least one rotor sheet, wherein rotor sheets of each group are located successively to each other in the axial direction, wherein in each rotor sheet group, the first flux guide sections are aligned with each other, and wherein the first flux guide sections of a rotor sheet group are aligned with the second flux guide sections of adjacent rotor sheet group.

17. The electric machine according to claim 16, wherein each flux guide section has an equal number of flux paths and an equal number of flux barriers compared to the other flux guide sections.

18. The electric machine according to claim 14, wherein each of the plurality of rotor sheets is identical with the rest of the plurality of rotor sheets.

19. The electric machine according to claim 14, wherein each flux guide section has an equal number of flux paths and an equal number of flux barriers compared to the other flux guide sections.

20. The electric machine according to claim 19, wherein except for the bridges, the first flux guide section and the second flux guide section are identical.
